(19) United States
(12) Patent Application Publication
(10) Pub. No.: US 2020/0151258 A1
(43) Pub. Date: May 14, 2020

(54) METHOD, COMPUTER DEVICE AND STORAGE MEDIUM FOR IMPEMENTING SPEECH INTERACTION

(71) Applicant: BAIDU ONLINE NETWORK TECHNOLOGY (BEIJING) CO., LTD., Beijing (CN)

(72) Inventors: Chao YUAN, Beijing (CN); Xiantang CHANG, Beijing (CN); Huailiang CHEN, Beijing (CN)

(73) Assignee: BAIDU ONLINE NETWORK TECHNOLOGY (BEIJING) CO., LTD., Beijing (CN)

(21) Appl. No.: 16/557,917

(22) Filed: Aug. 30, 2019

(30) Foreign Application Priority Data
Nov. 13, 2018 (CN) 201811344027.7

(51) Int. Cl. G06F 17/27; G10L 15/18; G10L 15/22; G10L 15/26; G10L 25/63

(52) U.S. Cl. CPC G06F 17/2785; G10L 15/1815; G10L 15/22; G10L 2015/227; G10L 25/63; G10L 2015/225; G10L 15/265

(57) ABSTRACT

The present disclosure provides a method, apparatus, computer device and storage medium for implementing speech interaction, wherein the method comprises: a content server obtaining a user's speech information from a client device, and completing the speech interaction in a first manner; the first manner comprises: sending the speech information to an automatic speech recognition server and obtaining a partial speech recognition result returned by the automatic speech recognition server each time; after determining that voice activity detection starts and if it is determined through semantic understanding that the partial speech recognition result obtained each time already includes entire content that the user hopes to express, taking the partial speech recognition result as a final speech recognition result, obtaining a response speech corresponding to the final speech recognition result, and returning the response speech to the client device. The solution of the present disclosure can be applied to improve the speech interaction response speed.

The present application claims the priority of Chinese Patent Application No. 201811344027.7, filed on Nov. 13, 2018, with the title of “Method, apparatus, computer device and storage medium for implementing speech interaction”. The disclosure of the above applications is incorporated herein by reference in its entirety.

### FIELD OF THE DISCLOSURE

The present disclosure relates to computer application technologies, and particularly to a method, apparatus, computer device and storage medium for implementing speech interaction.

### BACKGROUND OF THE DISCLOSURE

Human-machine speech interaction means implementing dialogue between a human being and a machine in a speech manner.

FIG. 1 is a schematic diagram of a processing flow of conventional human-machine speech interaction. As shown in FIG. 1, a content server may obtain the user's speech information from a client and send the speech information to an Automatic Speech Recognition (ASR) server, and then obtain a speech recognition result returned by the ASR server, initiate a request to search for a downstream vertical class service according to the speech recognition result, send the obtained search result to a Text To Speech (TTS) server, obtain a response speech generated by the TTS server according to the search result, and return the response speech to the client device.

During the human-machine speech interaction, a predictive prefetching method is usually employed to improve the speech interaction response speed.

FIG. 2 is a schematic diagram of an implementation mode of a conventional predictive prefetching method. As shown in FIG. 2, ASR start indicates that speech recognition is started, and ASR partial result indicates partial results of the speech recognition, such as: Bei-Beijing-Beijing's-Beijing's Weather, VAD start indicates the start (starting point) of the Voice Activity Detection, VAD end indicates the end (ending point) of the Voice Activity Detection, that is, the machine believes that the user's voice is finished, and VAD indicates Voice Activity Detection.

The ASR server sends partial speech recognition results obtained each time to the content server. The content server initiates a request to search for a downstream vertical class service according to the partial speech recognition results obtained each time, and sends the search results to the TTS server for speech synthesis. When the VAD ends, the content server may return a finally-obtained speech synthesis result as a response voice to the client device for broadcasting.

In practical application, before the VAD ends, it might occur a case that partial speech recognition results obtained at a certain time are already the final speech recognition results, for example, the user might not utter a speech between the VAD start and the VAD end. In this case, an operation such as initiating a search request during this period is substantively meaningless, not only increases consumption of resources but also prolongs the speech response time, i.e., reduces the speech interaction response speed.

### SUMMARY OF THE DISCLOSURE

In view of the above, the present disclosure provides a method, apparatus, computer device and storage medium for implementing speech interaction.

Specific technical solutions are as follows:

A method for implementing speech interaction, comprising:

a content server obtaining a user's speech information from a client device, and completing the speech interaction in a first manner;

the first manner comprises: sending the speech information to an automatic speech recognition server and obtaining a partial speech recognition result returned by the automatic speech recognition server each time; after determining that voice activity detection starts and if it is determined through semantic understanding that the partial speech recognition result obtained each time already includes entire content that the user hopes to express, taking the partial speech recognition result as a final speech recognition result, obtaining a response speech corresponding to the final speech recognition result, and returning the response speech to the client device.

According to a preferred embodiment of the present disclosure, the method further comprises:

for the partial speech recognition result obtained each time before and after the start of the voice activity detection, respectively obtaining a search result corresponding to the partial speech recognition result, and sending the search result to a Text To Speech server for speech synthesis;

upon obtaining the final speech recognition result, taking a speech synthesis result obtained according to the final speech recognition result as the response speech.

According to a preferred embodiment of the present disclosure, the method further comprises:

after the content server obtaining the user's speech information, obtaining the user's expression attribute information;

if it is determined according to the expression attribute information that the user is a user who expresses content completely at one time, completing the speech interaction in the first manner.

According to a preferred embodiment of the present disclosure, the method further comprises:

if it is determined according to the expression attribute information that the user is a user who does not express content completely at one time, completing the speech interaction in a second manner;

the second manner comprises:

sending the speech information to the automatic speech recognition server, and obtaining a partial speech recognition result returned by the automatic speech recognition server each time;

for the partial speech recognition result obtained each time, respectively obtaining a search result corresponding to the partial speech recognition result, and sending the search result to the Text To Speech server for speech synthesis;

upon determining that the voice activity detection ends, taking the finally-obtained speech syntheses result as the response speech, and returning the response speech to the client device.

According to a preferred embodiment of the present disclosure, the method further comprises: determining the user's expression attribute information by analyzing the user's past speaking expression habits.

A apparatus for implementing speech interaction, comprising: a speech interaction unit;

the speech interaction unit is configured to obtain a user's speech information from a client device, and complete the speech interaction in a first manner; the first manner comprises: sending the speech information to an automatic speech recognition server and obtaining a partial speech recognition result returned by the automatic speech recognition server each time; after determining that voice activity detection starts and if it is determined through semantic understanding that the partial speech recognition result obtained each time already includes entire content that the user hopes to express, taking the partial speech recognition result as a final speech recognition result, obtaining a response speech corresponding to the final speech recognition result, and returning the response speech to the client device.

According to a preferred embodiment of the present disclosure, the speech interaction unit is further configured to,

for the partial speech recognition result obtained each time before and after the start of the voice activity detection, respectively obtain a search result corresponding to the partial speech recognition result, and send the search result to a Text To Speech server for speech synthesis;

upon obtaining the final speech recognition result, regard a speech synthesis result obtained according to the final speech recognition result as the response speech.

According to a preferred embodiment of the present disclosure, the speech interaction unit is further configured to, after obtaining the user's speech information, obtain the user's expression attribute information, and if it is determined according to the expression attribute information that the user is a user who expresses content completely at one time, complete the speech interaction in the first manner.

According to a preferred embodiment of the present disclosure, the speech interaction unit is further configured to, if it is determined according to the expression attribute information that the user is a user who does not express content completely at one time, complete the speech interaction in a second manner; the second manner comprises: sending the speech information to the automatic speech recognition server, and obtaining a partial speech recognition result returned by the automatic speech recognition server each time; for the partial speech recognition result obtained each time, respectively obtaining a search result corresponding to the partial speech recognition result, and sending the search result to the Text To Speech server for speech synthesis; upon determining that the voice activity detection ends, taking the finally-obtained speech syntheses result as a response speech, and returning the response speech to the client device.

According to a preferred embodiment of the present disclosure, the apparatus further comprises: a pre-processing unit;

the pre-processing unit is configured to determine the user's expression attribute information by analyzing the user's past speaking expression habits.

A computer device, comprising a memory, a processor and a computer program which is stored on the memory and runs on the processor, the processor, upon executing the program, implementing the above-mentioned method.

A computer-readable storage medium on which a computer program is stored, the program, when executed by the processor, implementing the aforesaid method.

As may be seen from the above introduction, according to the solutions of the present disclosure, it is possible to, after determining that the voice activity detection starts and if it is determined through semantic understanding that the partial speech recognition result obtained each time already includes entire content that the user hopes to express, directly regard the partial speech recognition result as the final speech recognition result, obtain a corresponding response speech, return the response speech to the user for broadcasting, and end the speech interaction, without waiting for the end of the voice activity detection as in the prior art, thereby enhancing the speech interaction response speed, and reducing resource consumption by reducing times of initiating the search request.

### BRIEF DESCRIPTION OF DRAWINGS

FIG. 1 is a schematic diagram of a processing flow of conventional human-machine speech interaction.

FIG. 2 is a schematic diagram of an implementation mode of a conventional predictive prefetching method.

FIG. 3 is a flow chart of a first embodiment of a method for implementing speech interaction according to the present disclosure.

FIG. 4 is a flow chart of a second embodiment of a method for implementing speech interaction according to the present disclosure.

FIG. 5 is a structural schematic diagram of components of an embodiment of an apparatus for implementing speech interaction according to the present disclosure.

FIG. 6 illustrates a block diagram of an example computer system/server 12 adapted to implement an implementation mode of the present disclosure.

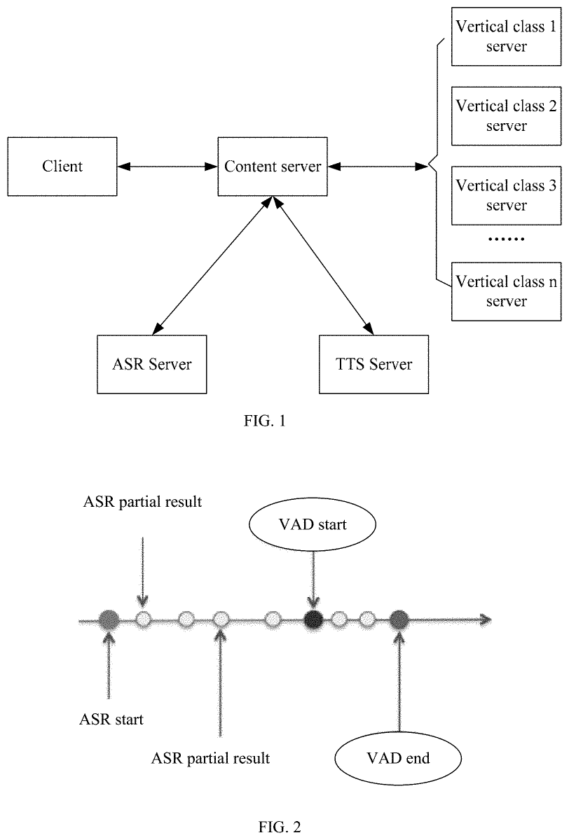

### DETAILED DESCRIPTION OF PREFERRED EMBODIMENTS

Technical solutions of the present disclosure will be described in more detail in conjunction with figures and embodiments to make technical solutions of the present disclosure clear and more apparent.

Obviously, the described embodiments are partial embodiments of the present disclosure, not all embodiments. Based on embodiments in the present disclosure, all other embodiments obtained by those having ordinary skill in the art without making inventive efforts all fall within the protection scope of the present disclosure.

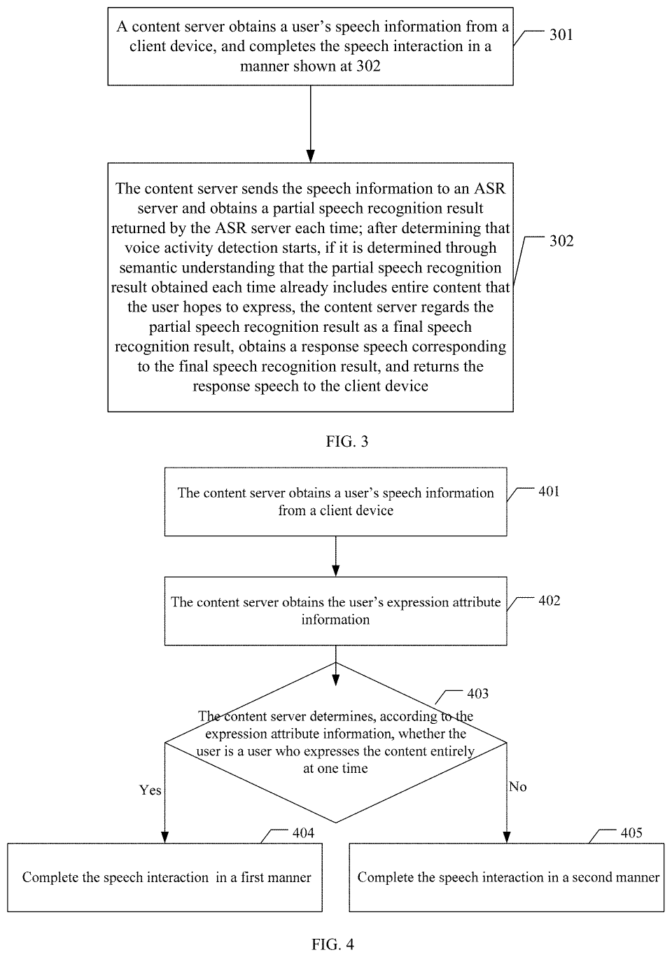

FIG. 3 is a flow chart of a first embodiment of a method for implementing speech interaction according to the present disclosure. As shown in FIG. 3, the following specific implementation mode is included.

At 301, a content server obtains a user's speech information from a client device, and completes the speech interaction in a manner shown at 302.

At 302, the content server sends the speech information to an ASR server and obtains a partial speech recognition result returned by the ASR server each time; after determining that voice activity detection starts, if it is determined through semantic understanding that the partial speech recognition result obtained each time already includes entire content that the user hopes to express, the content server regards the partial speech recognition result as a final speech recognition result, obtains a response speech corresponding to the final speech recognition result, and returns the response speech to the client device.

After obtaining the user's speech information through the client device, the content server may send the speech information to the ASR server, and perform subsequent processing in a current predictive prefetching manner.

The ASR server may send a partial speech recognition result generated each time to the content server. Accordingly, the content server may, for the partial speech recognition result obtained each time, respectively obtain a search result corresponding to the partial speech recognition result, and send the obtained search result to a TTS server for speech synthesis.

The content server may, for the partial speech recognition result obtained each time, respectively initiate a request to search for a downstream vertical class service according to the partial speech recognition result, obtain a search result and buffer the search result. The content server may also send the obtained search result to the TTS server, and based on the obtained search result, the TTS server may perform speech synthesis in a conventional manner. Specifically, when performing the speech synthesis, the TTS server may, for the search result obtained each time, supplement or improve the previously-obtained speech synthesis result based on the search result, thereby obtaining a final desired response speech.

When voice activity detection starts, the ASR server informs the content server. Subsequently, for the partial speech recognition result obtained each time, the content server may further determine, by semantic understanding, whether the partial speech recognition result already includes entire content that the user wishes to express, in addition to performing the above processing.

If the partial speech recognition result already includes entire content that the user wishes to express, the partial speech recognition result may be regarded as the final speech recognition result, that is, the partial speech recognition result is regarded as the content that the user finally wishes to express, and the speech synthesis result obtained according to the final speech recognition result may be returned to the client device as a response speech, and broadcast by the client device to the user, thereby completing the speech interaction. If the partial speech recognition result does not include entire content that the user wishes to express, relevant operations after the semantic understanding may be repeatedly performed for the partial speech recognition result obtained next time.

It can be seen that, compared with the conventional manner, the processing manner of the present embodiment still employs the predictive prefetching method, but differs from the existing manner in, after the start of the voice activity detection, additionally performing judgment for the partial speech recognition result obtained each time, judging whether the partial speech recognition result already includes entire content that the user wishes to express, and subsequently performing different operations according to different judgment results, and when the judgment result is yes, directly taking the partial speech recognition result as a final speech recognition result, obtaining a corresponding response speech, returning and broadcasting the response speech to the user, and finishing the speech interaction.

The process from the start to the end of the voice activity detection usually needs to take 600 to 700 ms in the conventional manner, but the processing manner described in the present embodiment usually may save time by 500 to 600 ms, and substantially improve the speech interaction response speed.

Furthermore, the processing manner according to the present embodiment, by finishing the speech interaction process in advance, reduces the times of initiating the search request, and thereby reduces resource consumption.

In practical application, it might occur the following case: between the start and the end of the voice activity detection, the user temporarily supplements some speech content. For example, after the user speaks “I want to watch Jurassic Park”, he speaks “2” after a 200 ms interval, and the content that the user hopes to express ultimately should be “I want to watch Jurassic Park 2”. However, if the processing manner in the above embodiment is employed, the obtained final speech recognition result is probably “I want to watch Jurassic Park”, and in this way, the content of the response speech finally obtained by the user is also content related to Jurassic Park, not content related to Jurassic Park 2.

Regarding the above case, it is proposed in the present disclosure that further optimization may be performed for the processing manner in the above embodiment, thereby avoiding the occurrence of the above case as much as possible and ensuring accuracy of the content of the response speech.

FIG. 4 is a flow chart of a second embodiment of a method for implementing speech interaction according to the present disclosure. As shown in FIG. 4, the following specific implementation mode is included.

At 401, the content server obtains a user's speech information from a client device.

At 402, the content server obtains the user's expression attribute information. Different users' expression attribute information may be determined by analyzing the users' past speaking expression habit, and may be updated as needed.

The expression attribute information, as an attribute of the user, is used to indicate whether the user is a user who expresses the content entirely at one time or a user who does not express the content entirely at one time.

The expression attribute information may be generated in advance, and may be directly queried when needed.

At 403, the content server determines, according to the expression attribute information, whether the user is a user who expresses the content entirely at one time, and if so, executes 404, otherwise, executes 405.

The content server may determine, according to the expression attribute information, whether the user is a user who expresses the content entirely at one time, and may subsequently perform different operations according to different determination results.

For example, for some elderly users, the content that they wish to express often cannot be finished in one go, then such users are users who express in entire content.

At 404, the speech interaction is completed in a first manner.

That is, the speech interaction is completed in the manner in the embodiment shown in FIG. 3, for example, the speech information is sent to the ASR server, the partial speech recognition result returned by the ASR server each time is obtained, and after it is determined that voice activity detection starts and if it is determined through semantic understanding that the partial speech recognition result already includes entire content that the user hopes to express, the partial speech recognition result is regarded as a final speech recognition result, a response speech corresponding to the final speech recognition result is obtained and returned to the client device for broadcasting.

At 405, the speech interaction is completed in a second manner.

The second manner may include: sending the speech information to the ASR server; obtaining a partial speech recognition result returned by the ASR server each time; and for the partial speech recognition result obtained each time, respectively obtaining a search result corresponding to the partial speech recognition result, and sending the search result to the TTS server for speech synthesis; upon determining that the voice activity detection ends, taking the finally-obtained speech syntheses result as a response speech, and returning the response speech to the client device for broadcasting.

For a user who does not express the content entirely at one time, the speech interaction may be completed in the above second manner, namely, the speech interaction may be completed in a conventional manner.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, embodiments are respectively described with respective focuses, and reference may be made to related depictions in other embodiments for portions not detailed in a certain embodiment.

In summary, the solution of the method embodiment of the present disclosure may be employed to, by performing semantic understanding and subsequent relevant operations for the partial speech recognition result, improve the speech interaction response speed and reduce resource consumption, and by employing different processing manners for users having different expression attributes, try to ensure the accuracy of the content of the response speech as much as possible.

The above introduces the method embodiments. The solution of the present disclosure will be further described through an apparatus embodiment.

FIG. 5 is a structural schematic diagram of components of an embodiment of an apparatus for implementing speech interaction according to the present disclosure. As shown in FIG. 5, the apparatus comprises a speech interaction unit 501.

The speech interaction unit 501 is configured to obtain a user's speech information from a client device, and complete the speech interaction in a first manner; the first manner includes: sending the speech information to an ASR server and obtaining a partial speech recognition result returned by the ASR server each time; after determining that voice activity detection starts and if it is determined through semantic understanding that the partial speech recognition result already includes entire content that the user hopes to express, taking the partial speech recognition result as a final speech recognition result, obtaining a response speech corresponding to the final speech recognition result, and returning the response speech to the client device.

For the partial speech recognition result obtained each time before and after the start of the voice activity detection, the speech interaction unit 501 may respectively obtain a search result corresponding to the partial speech recognition result, and send the search result to a TTS server for speech synthesis. When performing the speech synthesis, the TTS server may, for the search result obtained each time, supplement or improve the previously-obtained speech synthesis result based on the search result.

After determining that the voice activity detection starts, for the partial speech recognition result obtained each time, the speech interaction unit 501 may further determine, by semantic understanding, whether the partial speech recognition result already includes entire content that the user wishes to express, in addition to performing the above processing.

If the partial speech recognition result already includes entire content that the user wishes to express, the partial speech recognition result may be regarded as the final speech recognition result, that is, the partial speech recognition result is regarded as the content that the user finally wishes to express, and the speech synthesis result obtained according to the final speech recognition result may be returned to the client device as a response speech, and broadcast by the client device to the user, thereby completing the speech interaction. If the partial speech recognition result does not include entire content that the user wishes to express, relevant operations after the semantic understanding may be repeatedly performed for the partial speech recognition result obtained next time.

Preferably, the speech interaction unit 501 may further, after obtaining the user's speech information, obtain the user's expression attribute information, and if it is determined according to the expression attribute information that the user is a user who expresses content completely at one time, complete the speech interaction in the first manner.

If it is determined according to the expression attribute information that the user is a user who does not express content completely at one time, the speech interaction unit 501 may complete the speech interaction in the second manner; the second manner comprises: sending the speech information to the ASR server; obtaining a partial speech recognition result returned by the ASR server each time; and for the partial speech recognition result obtained each time, respectively obtaining a search result corresponding to the partial speech recognition result, and sending the search result to the TTS server for speech synthesis; upon determining that the voice activity detection ends, taking the finally-obtained speech syntheses result as a response speech, and returning the response speech to the client device for broadcasting.

Correspondingly, the apparatus shown in FIG. 5 may further include: a pre-processing unit 500 configured to determine different users' expression attribute information by analyzing the users' past speaking expression habits, to facilitate query by the speech interaction unit 501.

Reference may be made to relevant depictions in the above method embodiments for a specific workflow of the above apparatus embodiment shown in FIG. 5, which will not be detailed any more here.

To sum up, the solution of the apparatus embodiment of the present disclosure may be employed to, by performing semantic understanding and subsequent relevant operations for the partial speech recognition result, improve the speech interaction response speed and reduce resource consumption, and by employing different processing manners for users having different expression attributes, try to ensure the accuracy of the content of the response speech as much as possible.

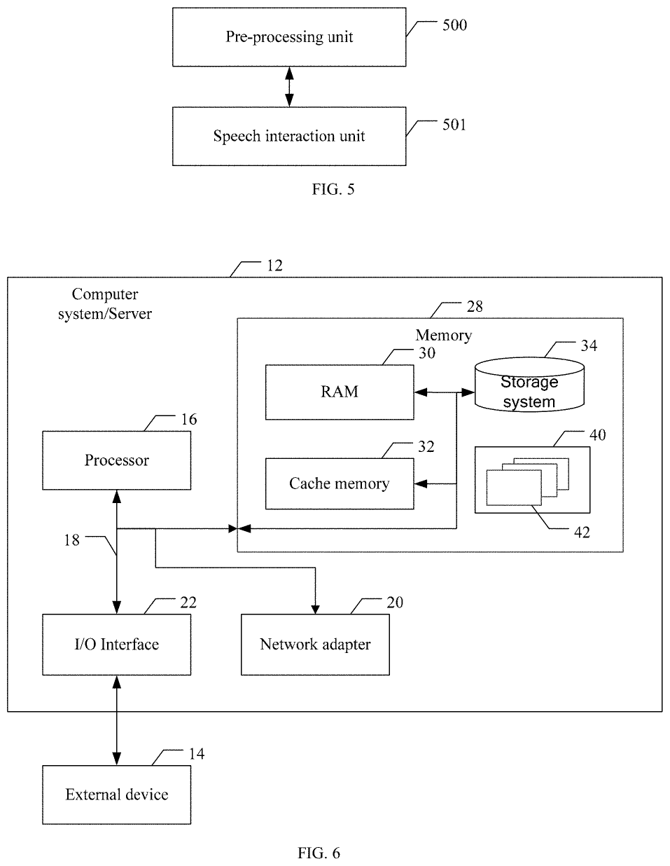

FIG. 6 illustrates a block diagram of an example computer system/server 12 adapted to implement an implementation mode of the present disclosure. The computer system/server 12 shown in FIG. 6 is only an example and should not bring about any limitation to the function and scope of use of the embodiments of the present disclosure.

As shown in FIG. 6, the computer system/server 12 is shown in the form of a general-purpose computing device. The components of computer system/server 12 may include, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 may include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 may be provided for reading from and writing to a non-removable, non-volatile magnetic media (not shown in FIG. 6 and typically called a “hard drive”). Although not shown in FIG. 6, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each drive may be connected to bus 18 by one or more data media interfaces. The memory 28 may include at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might include an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication may occur via Input/Output (I/O) interfaces 22. Still yet, computer system/server 12 may communicate with one or more networks such as a local area network (LAN), a general wide area network (WAN), and/or a public network (e.g., the Internet) via network adapter 20. As depicted in FIG. 6, network adapter 20 communicates with the other communication modules of computer system/server 12 via bus 18. It should be understood that although not shown, other hardware and/or software modules could be used in conjunction with computer system/server 12. Examples, include, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the method in the embodiment shown in FIG. 3 or FIG. 4.

The present disclosure meanwhile provides a computer-readable storage medium on which a computer program is stored, the program, when executed by the processor, implementing the method stated in the embodiment shown in FIG. 3 or FIG. 4.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium may be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed apparatus and method may be implemented in other ways. For example, the above-described embodiments for the apparatus are only exemplary, e.g., the division of the units is merely logical one, and, in reality, they may be divided in other ways upon implementation.

The units described as separate parts may be or may not be physically separated, the parts shown as units may be or may not be physical units, i.e., they may be located in one place, or distributed in a plurality of network units. One may select some or all the units to achieve the purpose of the embodiment according to the actual needs. Further, in the embodiments of the present disclosure, functional units may be integrated in one processing unit, or they may be separate physical presences; or two or more units may be integrated in one unit. The integrated unit described above may be implemented in the form of hardware, or they may be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method for implementing speech interaction, wherein the method comprises:
a content server obtaining a user's speech information from a client device, and completing the speech interaction in a first manner;
the first manner comprises: sending the speech information to an automatic speech recognition server and obtaining a partial speech recognition result returned by the automatic speech recognition server each time; after determining that voice activity detection starts and if it is determined through semantic understanding that the obtained partial speech recognition result already includes entire content that the user hopes to express, taking the partial speech recognition result as a final speech recognition result, obtaining a response speech corresponding to the final speech recognition result, and returning the response speech to the client device.

2. The method according to claim 1, wherein
the method further comprises:
for the partial speech recognition result obtained each time before and after the start of the voice activity detection, respectively obtaining a search result corresponding to the partial speech recognition result, and sending the search result to a Text To Speech server for speech synthesis;
upon obtaining the final speech recognition result, taking a speech synthesis result obtained according to the final speech recognition result as the response speech.

3. The method according to claim 1, wherein
the method further comprises:
after the content server obtaining the user's speech information, obtaining the user's expression attribute information;
if it is determined according to the expression attribute information that the user is a user who expresses content completely at one time, completing the speech interaction in the first manner.

4. The method according to claim 3, wherein
the method further comprises:
if it is determined according to the expression attribute information that the user is a user who does not express content completely at one time, completing the speech interaction in a second manner;
the second manner comprises:
sending the speech information to the automatic speech recognition server, and obtaining a partial speech recognition result returned by the automatic speech recognition server each time;
for the partial speech recognition result obtained each time, respectively obtaining a search result corresponding to the partial speech recognition result, and sending the search result to the Text To Speech server for speech synthesis;
upon determining that the voice activity detection ends, taking the finally-obtained speech syntheses result as the response speech, and returning the response speech to the client device.

5. The method according to claim 3, wherein
the method further comprises: determining the user's expression attribute information by analyzing the user's past speaking expression habits.

6. A computer device, comprising a memory, a processor and a computer program which is stored on the memory and runs on the processor, wherein the processor, upon executing the program, implements a method for implementing speech interaction, wherein the method comprises:
a content server obtaining a user's speech information from a client device, and completing the speech interaction in a first manner;
the first manner comprises: sending the speech information to an automatic speech recognition server and obtaining a partial speech recognition result returned by the automatic speech recognition server each time; after determining that voice activity detection starts and if it is determined through semantic understanding that the obtained partial speech recognition result already includes entire content that the user hopes to express, taking the partial speech recognition result as a final speech recognition result, obtaining a response speech corresponding to the final speech recognition result, and returning the response speech to the client device.

7. A computer-readable storage medium on which a computer program is stored, wherein the program, when executed by a processor, implements a method for implementing speech interaction, wherein the method comprises:
a content server obtaining a user's speech information from a client device, and completing the speech interaction in a first manner;
the first manner comprises: sending the speech information to an automatic speech recognition server and obtaining a partial speech recognition result returned by the automatic speech recognition server each time; after determining that voice activity detection starts and if it is determined through semantic understanding that the obtained partial speech recognition result already includes entire content that the user hopes to express, taking the partial speech recognition result as a final speech recognition result, obtaining a response speech corresponding to the final speech recognition result, and returning the response speech to the client device.
